(19) United States
(12) Patent Application Publication
(10) Pub. No.: US 2011/0273789 A1
(43) Pub. Date: Nov. 10, 2011

(54) Linear motor with integral position sensor

(75) Inventor: Horst Knoedgen, Munich (DE)

(73) Assignee: Digital Imaging Systems GmbH

(21) Appl. No.: 12/799,947

(22) Filed: May 5, 2010

(51) Int. Cl. G02B 7/04; H02K 41/035; G05B 1/02

(52) U.S. Cl. 359/824; 318/653; 310/12.24

(57) ABSTRACT

Systems and methods for a linear motor having an integrated position sensing of the anchor of the motor are disclosed. An integrated position sensing of the anchor is achieved by sensing the inductance of one or more coils driving the anchor. The anchor comprises at least one permanent magnet. The inductance is dependent on a current position of the anchor. The anchor is driven by PWM pulses. A control unit controls the duration of driving the anchor and the duration of sensing the inductance. In normal operation during about 80% of a motor control period the anchor is driven and during a remaining time the inductance is sensed. In a preferred embodiment of the invention the linear motors invented are used in a camera module driving a lens barrel and a shutter.

### RELATED APPLICATIONS

This application is related to the following US patent applications:

DI09-003/004, titled “Camera Module having a low-friction movable lens”, Ser. No. 12/661,752, filing date Mar. 23, 2010,

DI08-006, titled “Camera Shutter and position control thereof”, Ser. No. 12/658,280, filing date Feb. 5, 2010, and

DI09-007, titled “Twin-actuator configuration for a camera module”, Ser. No. 12/661,755, filing date Mar. 23, 2010,

and the above applications are herein incorporated by reference in their entirety.

### BACKGROUND OF THE INVENTION

(1) Field of the Invention

This invention relates generally to linear motors and relates more specifically to miniature linear motors used preferably for camera modules having an integrated position sensor related to a movable part of the motor.

(2) Description of the Prior Art

Digital camera modules are used with many electronic devices such as e.g. mobile phones, personal data assistants (PDAs), computers, etc. These camera modules have to be as small as possible, reliable, and easy to be used, robust and require minimal power consumption. Furthermore the design of the camera modules should allow low manufacturing cost, while the quality of the images has to conform to a high standard.

Therefore modern camera modules should allow auto-focusing or zooming with minimal size without electrical connections to a movable part. It is a challenge for the designers of camera modules to develop linear motors to drive a lens barrel, wherein the motors have minimal size and allowing a precise focus position for the camera lens.

There are known patents or patent publications dealing with the design of linear motors for camera modules.

U.S. Patent Publication (US 2006/0018643 to Stavely et al.) teaches a sensor mounting system for enabling image stabilization in a digital camera. An electronic array light sensor is moved in relation to other parts of the camera in response to camera motion. In one embodiment, the sensor is moved by at least one linear motor having a ferrofluid in a gap of the linear motor. Each of four coils and an associated set of complementary magnets forms a moving coil linear motor, wherein the magnets are the stator of the linear motor, and the coil is part of the moving member of the linear motor.

U.S. Patent Publication (US 2006/0132640 to Tirole et al.) discloses an optical lens assembly including a light-sensitive member; first and second lenses/lens groups with their respective optical axis aligned with each other along a common optical axis; and first and second piezo electric ultrasonic linear motors; in which the first motor is operable to move the first and second lenses/lens groups relative to each other to vary their distance; and the second motor is operable to move the light-sensitive member or at least one of the first and second lenses/lens groups to vary the distance between the light-sensitive member and the lens/lens group. There is further disclosed a driving IC for driving a piezo electric ultrasonic linear motor in response to the result arrived at by the auto-focus judge.

U.S. Patent (U.S. Pat. No. 6,157,100 to Mielke) describes an electromagnetic drive for a focal-plane shutter of a camera having two light-excluding shutter curtains, each of the two shutter curtains being having its own electric drive motor, which is a linear motor constructed from permanent magnets and electromagnetic coils. The linear motor has at least two mutually aligned permanent magnets. The opposite pole faces of the magnets have the same polarity.

### SUMMARY OF THE INVENTION

A principal object of the present invention is to achieve methods and systems for a linear motor having an integrated position sensing of an anchor of the motor.

A further object of the present invention is to achieve a linear motor of a minimal size.

A further object of the present invention is to achieve a linear motor of minimal power consumption.

Another object of the present invention is to achieve a linear motor, wherein the inductance of coils can be sensed.

A further object of the present invention is to achieve a camera having a low-friction and precise positioning of a lens barrel and of a shutter.

Moreover an object of the present invention is to achieve a linear motor, which does not require any electrical connection to a movable part of the motor.

In accordance with the objects of this invention a method for a linear motor having an integrated position sensing of the anchor of the motor has been achieved. The method invented comprises the steps of (1) providing a linear motor comprising at least one coil and a movable anchor comprising at least one permanent magnet, and a pulse generating means, (2) driving the anchor of the motor towards a target position by inductive force generated by current pulses through said at least one coil during one part of a motor control period, and (3) sensing the current position of the anchor by sensing the inductance of said at least one coil coupled inductively with the anchor during a remaining part of the motor control period. Furthermore the method invented comprises (4) checking if a target position of the anchor is reached and, if so, go to step (5), else go to step (2); and, finally, (5) end.

In accordance with the objects of this invention a linear motor having an integrated position sensing of the anchor of the motor has been achieved. The linear motor invented comprises, firstly, at least one coil to drive the anchor of the motor, a means to generate electrical pulses, and said anchor comprising at least one permanent magnet. Furthermore the linear motor comprises a means to sense the inductance of the at least one coil wherein the inductance of at least one coil is dependent upon the position of said anchor, and a control unit to control driving of the anchor and the sensing of the inductance.

In accordance with the objects of this invention a camera using linear motors having integrated position sensing for positioning of components has been achieved. The linear motor invented comprises, firstly, an image sensor, a shutter with an aperture function driven by a linear motor, and said linear motor driving the shutter, wherein the motor has an integrated position sensing system. Furthermore the camera comprises a movable lens barrel, at least two linear motors moving to move said lens barrel, and an integrated circuit controlling the motor driving the shutter and the actuators moving the lens barrel. Finally the camera invented comprises rolling elements bearings guiding said lens barrel and said shutter, wherein the rolling elements of the bearings are moving between moving and fixed components of the camera module.

### BRIEF DESCRIPTION OF THE DRAWINGS

In the accompanying drawings forming a material part of this description, there is shown:

FIG. 1a shows basic components of a first preferred embodiment of the invention having two coils and two permanent magnets.

FIG. 1b shows an alternative implementation of a linear motor of the present invention using two coils and one permanent magnet only.

FIG. 1c shows another embodiment of the present invention using two coils and two permanent magnets 11 and 12 deployed on opposite sides of the coils.

FIG. 2 shows a cross section of a rotational symmetrical embodiment of the linear motor invented having a permanent magnet moving inside of two coils.

FIG. 3 illustrates a motor control period, comprising the time required for driving the motor by pulse-width modulation (PWM) pulses and the time required for measuring the position.

FIG. 4 depicts the basic components to drive a motor of the present invention.

FIG. 5 illustrates the magnetic coupling of both coils/solenoids of a linear motor of the present invention used for a position measurement.

FIG. 6 shows input signals and output signals of the circuit of FIG. 5 wherein the anchor is located at a mid point between both coils of the motor.

FIG. 7 shows input signals and output signals of the circuit of FIG. 5 wherein the anchor is located far outside of the mid point between both coils of the motor.

FIG. 8 shows input signals and output signals of the circuit of FIG. 5 wherein the anchor is located far outside of the mid point but on the other side than shown in FIG. 7.

FIG. 9 illustrates a basic switching arrangement of a normal operation and a “high torque” operation.

FIG. 10 illustrates a flowchart of a method invented for a linear motor having an integrated position sensing of the anchor of the motor.

FIG. 11a illustrates how the inductance of the coil of the linear motor changes if the permanent magnet moves above the coil.

FIG. 11b shows an embodiment of a linear motor of the present invention comprising one coil and one permanent magnet.

FIG. 12 illustrates a camera module using linear motors of the present invention having an integrated position sensing of the anchor by sensing the inductance of one or more coils driving the anchor.

### DESCRIPTION OF THE PREFERRED EMBODIMENTS

The preferred embodiments disclose methods and systems to achieve a bi-directional linear motor, having an integrated position sensing of a movable part of the motor. In preferred embodiments of the invention the motors invented are used to move a lens barrel of a camera module. The motor has to be of minimal size, and should have minimal power consumption without requiring an electrical connection to a movable part of the motor.

The preferred embodiments of the linear motor have different tasks to perform:

1. Generate a force to move a lens barrel to a position desired.
2. Detect a current position of the lens barrel.

In case ball bearings are used to guide the movements of the lens barrel a third task is to be performed:

3. Generate a force to retain the ball bearings.

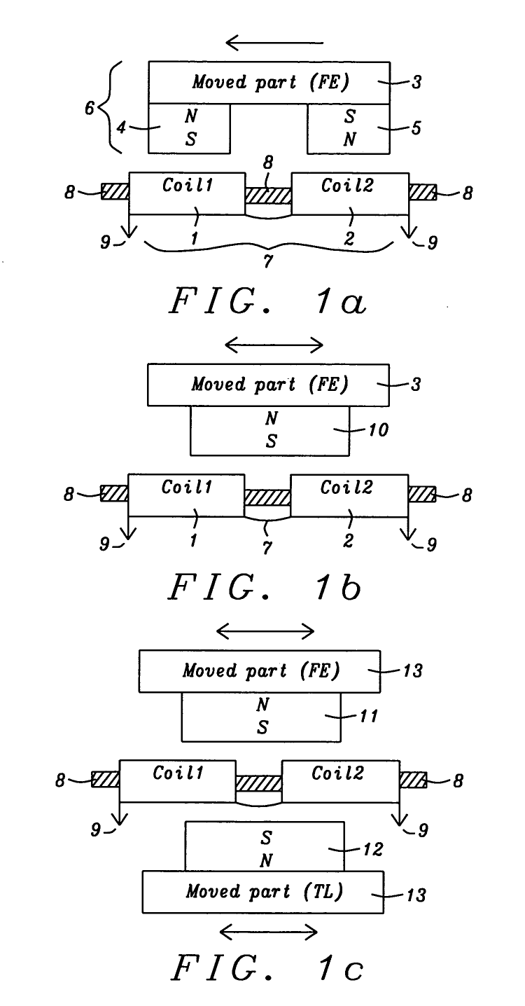

FIG. 1a shows basic components of a first preferred embodiment of the invention having two coils and two permanent magnets. The bi-directional linear motor comprises a stator 7, which is a fixed part of the motor, comprising two coils 1 and 2, being interconnected, wherein the coils 1 and 2 are wrapped around magnetic metal 8. In a preferred embodiment of the invention the stator 7 is a fixed part of the motor, which is firmly fastened on a carrier of the camera module. The power connections of the coils 1 and 2 are signified by numeral 9.

The anchor 6 of the motor, which is the movable part of the motor, comprises a piece of magnetic iron 3 and two permanent magnets 4 and 5. The direction of movements is indicated by the double-sided arrow. A possible magnetic orientation of both magnets 4 and 5 is indicated in FIG. 1a. The magnetic orientation could also be vice versa as well as shown in FIG. 1a.

The direction of the movement of the anchor 6 is depending upon the direction of a current through the coils 1 and 2, which are generating a magnetic flux through the anchor 6, the stator 7 and through the permanent magnets 4 The permanent magnet 4 ensures a stable position of the anchor if no currents are flowing through the coils.

FIG. 1b shows an alternative implementation of a linear motor of the present invention using two coils and one permanent magnet 10 only. The stator 7 of the linear motor of FIG. 1b has the same structure as the stator shown in FIG. 1a, having two coils 1 and 2 wrapped around magnetic metal 8 as e.g. iron.

Furthermore FIG. 1c shows another embodiment of the present invention using two coils and two permanent magnets 11 and 12 deployed on opposite sides of the coils. Similar to FIG. 1b this motor has two coils, coil 1, and coil 2, wrapped around an iron rod 8. Using two identical magnets 11 and 12 would double the moving force but would eliminate any force in direction to the iron 8, i.e. a rolling elements bearing guiding the moving part 13. Using rolling elements bearing, such as ball bearing (not shown), e.g. ball bearing or roller bearing, guiding the moving part 13, which comprise also iron. A force in direction to the rolling elements bearing is desirable to keep the rolling elements bearing together in case of a mechanic shock. Therefore in a preferred embodiment the two magnets are not identical, i.e. having a different magnetic strength, in order to generate a force towards the iron rod 8, this means towards the rolling elements bearing used. In case other bearings are used both magnets can be identical.

It would be also possible to implement the motors of FIGS. 1 and 1b using one coil only but then it will be very difficult to sense the position of the anchor 6 by sensing the inductance of the single coil, which is dependent upon the position of the anchor. Using one coil only does not allow any differential measurement of the inductance of both coils.

FIG. 2 shows a cross section of a rotational symmetrical embodiment of the linear motor invented having a permanent magnet moving inside of two coils. This solenoid linear motor comprises two solenoids or coils 20 and 21, which belong to a fixed part (stator) of the motor, a magnetic tube 23 around the coils 20 and 21, which belongs also to the fixed part of the motor, and an anchor 22 in a form of a rod, which can move by magnetic force inside of the coils 20 and 21, dependent upon the direction of currents through the coils. The tube 23 may have openings; the openings have to be deployed in a way to still allow a magnetic flux through the tube. The anchor 22 is a permanent magnet, in a preferred embodiment of the invention a neodymium magnet is used for the anchor 22. In a preferred application of the solenoid motor the anchor 21 is firmly connected to a movable part of a camera module, e.g. a shutter, which is moved to a desired position dependent on the currents through the coils 20 and 21.

By moving the anchor, i.e. changing the position of the magnet or magnetic material, the inductance of the solenoid motor changes. Sensing the inductance is used to sense the position of the anchor. The absolute value of the inductance can be measured or the difference of inductance between both solenoids. The anchor of the solenoid motor is designed in a way that the inductance of a first solenoid is increased if the anchor is moved inside this solenoid while the inductance of the other solenoid decreases at the same time because the anchor is moved towards the outside of the second solenoid.

Alternatively it would be possible to drive the motor of FIG. 2 with only one coil. In this case it would be very difficult to determine the position of the anchor by measuring the inductance of this single coil.

It should be noted that many variations of the linear motor of the present invention are possible, as e.g. using one or two coils, using one or two permanent magnets, a rotational symmetrical motor or not, using permanent magnets of different magnetic strength or identical magnets, etc.

FIG. 2a shows another embodiment of the linear motor invented having an integrated position-sensing correspondent a solenoid concept. This motor is characterized by an anchor 24 having in its middle part 25 non-magnetic materials as e.g. plastic. This solenoid linear motor comprises two solenoids 20 and 21, which belong to a fixed part (stator) of the motor, and the anchor 24 in a form of a rod, which can move by magnetic force inside of the solenoids 20 and 21. In case magnetic metal is used at the ends 26 of the anchor 24, a solenoid can move the anchor in the direction towards the inside of the solenoid only. In case permanent magnets are used at the ends of the anchor a solenoid can move the anchor in both directions.

In regard of the electrical driving system of the present invention it should be noted that during one motor control period about 80% of the time is used to drive the linear motor and about 20% of the time is used to measure the position of the anchor.

FIG. 3 illustrates such a motor control period 30, comprising the time 31 required for driving the motor by pulse-width modulation (PWM) pulses and the time 32 required for measuring the position.

The duration of a time period 30 can be changed on the fly. In case the anchor of the motor is close to a target position the driving force can be reduced, the speed of the anchor is reduced and more time can be used to measure the current position. Therefore a hard stop of the anchor can be avoided. The position measurement is performed by short pulses. A control unit controls the duration of such a motor control period and the time used for driving the motor and the time used for sensing the inductance.

The driving time depends upon the force of the motor. The force of the motor follows the equation:

F=I×B_{L}×A,

wherein F is the force of the motor, I is the current through one or more coils, B_{L} signifies the strength of the magnetic field, and A signifies the active area of the magnet.

FIG. 11b shows an embodiment of a linear motor of the present invention comprising one coil 110 and one permanent magnet 111. The magnet 111 moves in the directions dependent upon the direction of the current through coil 110. The magnet may have a magnetic induction, as a non-limiting example, of 1.5 Tesla.

FIG. 11a illustrates how the inductance of the coil 110 changes if the permanent magnet 111 moves above the coil 110, as indicated by the arrows. FIG. 11a shows the dependency of a multiplication factor μᵣ upon the distance from the center of coil 110. The multiplication factor μᵣ signifies how the inductance increases if the permanent magnet 111 moves e.g. in direction of the center of the coil 110, i.e. if the magnet 111 approaches the coil 110 the inductance of the coil 110 increases by the factor μᵣ. This dependency of the inductance upon the distance from the center of the coil 110 is used to sense the actual position of the magnet. The same effect can be achieved using a motor according FIG. 2, i.e. a permanent magnet is moving inside of one or more coils. The inductance of the coil depends also, similarly to the example of FIG. 11a, upon the distance of the magnet from the center of the coil.

FIG. 4 depicts the basic components to drive a motor of the present invention. The buffers U1 and U2 are driving the motor and generate also short pulses used for position measurement. This can be performed for a bi-directional motor having two coils or correspondently two solenoids 40 and 41. A mid-point 42 is used for read-out of the position measurement, which is connected to a gain stage a sample-and hold stage and potentially to an analog-to-digital converter.

FIG. 5 illustrates the magnetic coupling of both coils/solenoids of a linear motor of the present invention used for a position measurement. Continuously changing inductances of both coils 1 and 2 are indicated by L1-5 (coil 1) and by L6-10 (coil 2). The continuously changing inductances should demonstrate the variable inductances being dependent upon the current position of the anchor of the motor. In FIG. 5 inductance values of 50 μH are assigned to each “partial” inductances L1-10. These “partial” inductances have been introduced only to explain the continuously changing inductances having actually a minimal resolution and could be much smaller in reality. It should be understood that these values should only indicate the order of magnitude of the continuously changing inductances shown. Resistor R2 is not a real resistor, it is only a “virtual complex impedance” used to illustrate interactions between both coils. These interactions are caused by a magnetic coupling between both coils 1 and 2 similar to a transformer and by impacts of moving magnets and metals on the inductances of both coils. Drivers 51 and 52 generate short pulses. Buffers U1 and U2, shown in FIG. 4, could be used for generating these short pulses as well.

Signals representing a current position of the anchor of the motor are taken from the midpoint 42 of the circuit of FIG. 5 via resistor R1 at the port 53. FIGS. 6-8 illustrate these signals wherein the anchor has different positions.

FIG. 6 shows input signals 60 and output signals 61 of the circuit of FIG. 5 wherein the anchor is located at a mid point between both coils of the motor.

FIG. 7 shows input signals 60 and output signals 61 of the circuit of FIG. 5 wherein the anchor is located far outside of the mid point between both coils of the motor. The output signal of FIG. 7 is much stronger than the output signal of FIG. 6 because the difference of inductance is much higher because the anchor is completely inside one coil and almost completely outside the other coil, or correspondently, referring to the motor of FIG. 1a, one permanent magnet is completely over one coil and the other magnet is located between both coils.

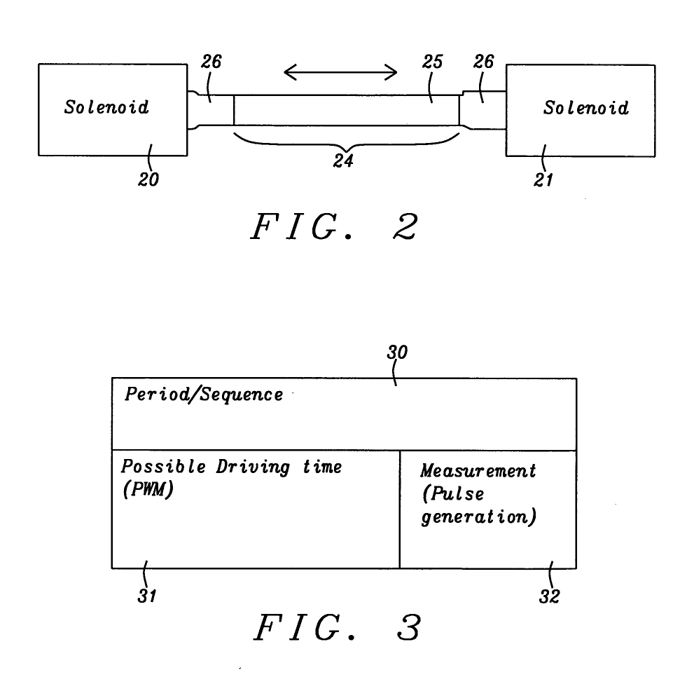

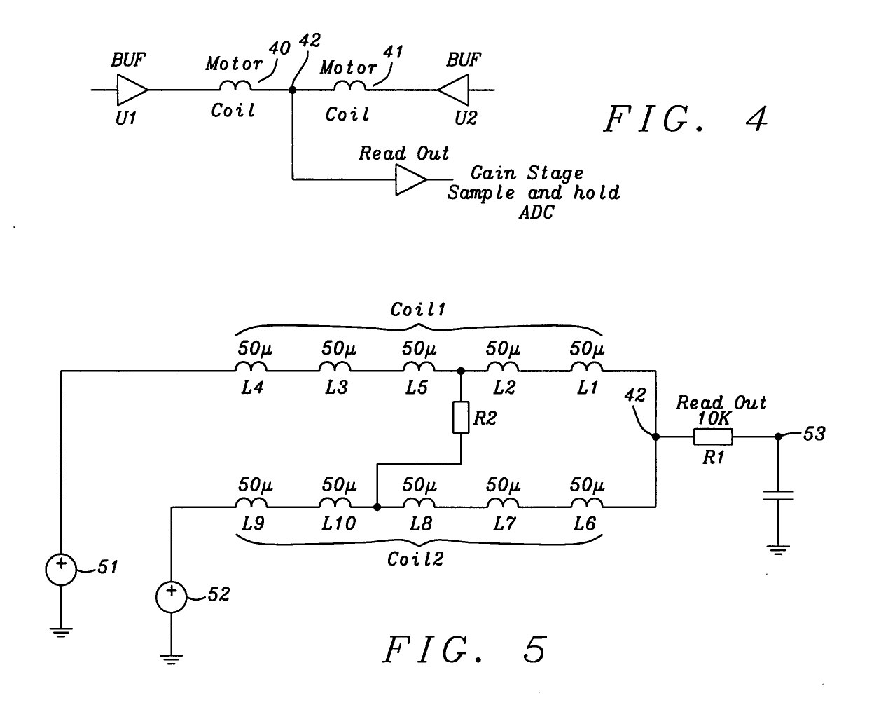

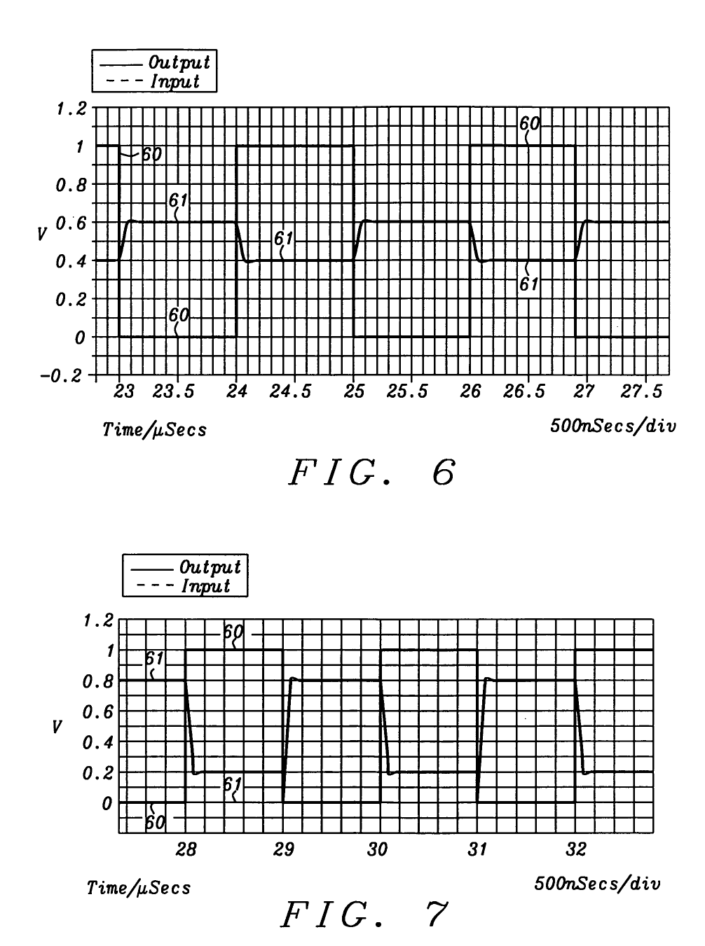

FIG. 8 shows input signals 60 and output signals 61 of the circuit of FIG. 5 wherein the anchor is located far outside of the mid point but on the other side than shown in FIG. 7. The output signal 61 is as strong as the output signal shown in FIG. 7 but it has changed its polarity.

If a load of the anchor, e.g. a lens barrel, is blocked, e.g. by a blocked ball bearing it the problem of blocking can be solved by increasing the torque of the motor. This can be achieved by driving the coils in parallel. In this case the current through the coils will be four times higher. Additionally in order to reduce a friction a modulation of several KHz can be given to the motor for a short time and during this time the friction will be converted from a static friction to a sliding friction.

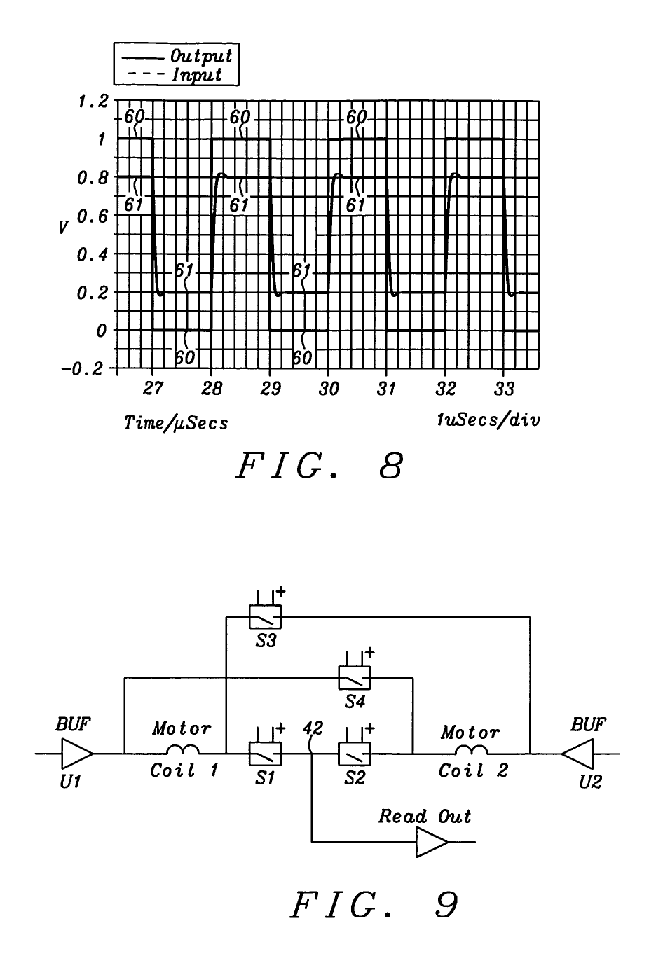

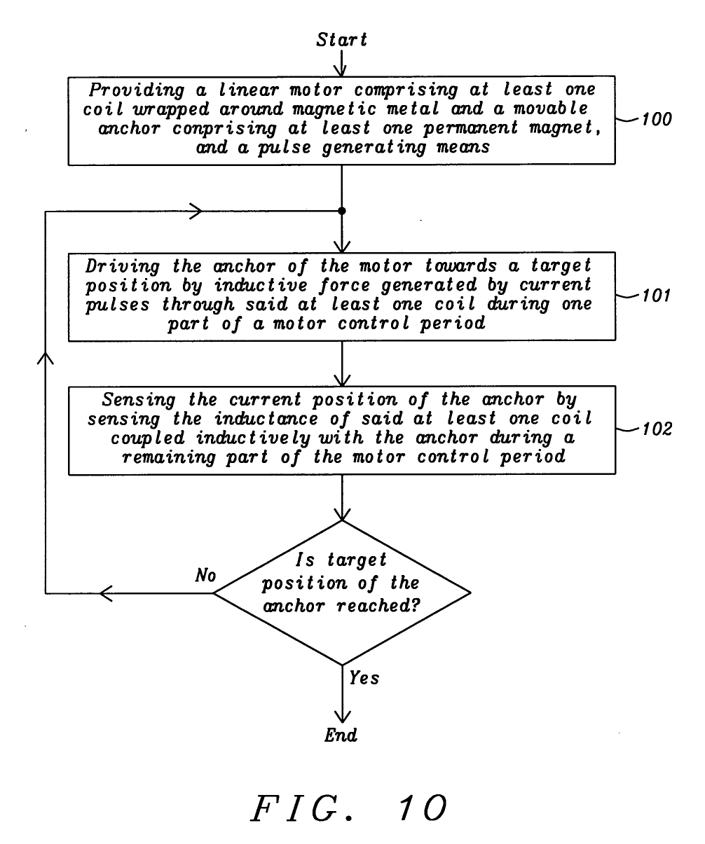

FIG. 9 illustrates a basic switching arrangement of a normal operation and a “high torque” operation. The circuit of FIG. 9 shows both motor coils 1 and 2, the buffers U1 and U2 are driving the motor and are also used to generate short pulses for the position measurement. The read-out of the position measurement is performed at mid-point 42.

During normal operation switches S1 and S2 are closed and switches S3 and S4 are open. During “high torque” operation switches S1 and S2 are open and switches S3 and S4 are closed. In this “high torque” mode both coils of the motor are driven in parallel.

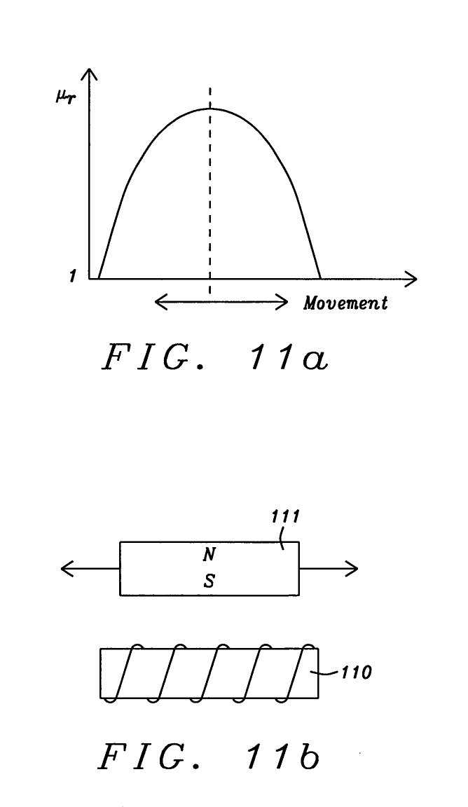

FIG. 10 illustrates a flowchart of a method invented for a linear motor having an integrated position sensing of the anchor of the motor. A first step 100 describes the provision of a linear motor comprising at least one coil and a movable anchor comprising at least one permanent magnet, and a pulse generating means. The next step 101 illustrates driving the anchor of the motor towards a target position by inductive force generated by current pulses through said at least one coil during one part of a motor control period. The following step 102 describes sensing the current position of the anchor by sensing the inductance of said at least one coil coupled inductively with the anchor during a remaining part of the motor control period. The last step 103 discloses checking if a target position of the anchor is reached and, if so, go to end, else go to step 101.

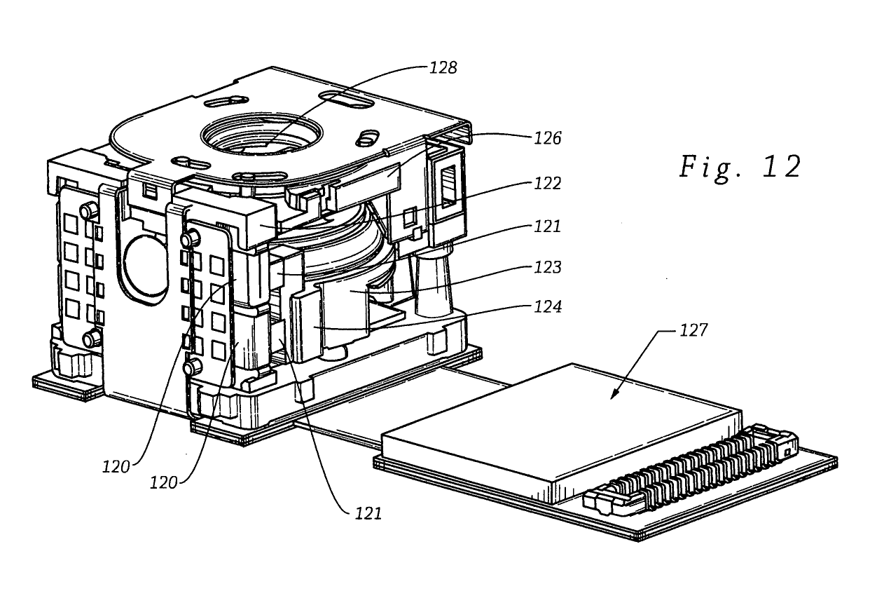

FIG. 12 illustrates a camera module using embodiments of linear motors as shown in FIG. 1a having an integrated position sensing of the anchor by sensing the inductance of one or more coils driving the anchor. The linear motors invented can be used to position a lens barrel for auto focus functions and to position a shutter.

FIG. 12 shows an oblique 3-dimensional view of a camera module according to having linear motors having two coils 120 as part of the stator 122 and two permanent magnets 121 as part of the anchor 124. As outlined above other embodiments of the motors having e.g. only one coil or one permanent magnet could be used as well. Furthermore FIG. 12 shows a movable lens barrel 123 carrying a shutter unit 126 with an aperture motor according to the present invention. The lens barrel 123 and the shutter are guided by rolling elements bearings, such as ball bearings. Roller bearings would be suitable as well. Rolling elements such as e.g. balls are moving between a moving part, i.e. the lens barrel or shutter, and a fixed part of the camera. The control of the shutter which is carried by the lens barrel is disclosed in the patent application DI08-006, titled “Camera Shutter and position control thereof”, Ser. No. 12/658,280, filing date Feb. 5, 2010.

Furthermore FIG. 3 shows an opening 128 of a lens/shutter system. The camera module invented furthermore comprises an integrated circuit (IC) 127 controlling the actuators of the present invention, an image sensor. This IC 127 also controls one or more motors with integrated position control to move shutter blades of the shutter unit 126.

While the invention has been particularly shown and described with reference to the preferred embodiments thereof, it will be understood by those skilled in the art that various changes in form and details may be made without departing from the spirit and scope of the invention.

What is claimed is:

1. A method for a linear motor having an integrated position sensing of the anchor of the motor, comprising the following steps:
(1) providing a linear motor comprising at least one coil and a movable anchor comprising at least one permanent magnet, and a pulse generating means;
(2) driving the anchor of the motor towards a target position by inductive force generated by current pulses through said at least one coil during one part of a motor control period;
(3) sensing the current position of the anchor by sensing the inductance of said at least one coil coupled inductively with the anchor during a remaining part of the motor control period;
(4) checking if a target position of the anchor is reached and, if so, go to step (5), else go to step (2); and
(5) end.

2. The method of claim 1 wherein said linear motor is used in a camera module.

3. The method of claim 2 wherein said linear motor is used to move a lens barrel.

4. The method of claim 2 wherein said linear motor is used to move a shutter.

5. The method of claim 1 wherein said linear motor comprises two coils.

6. The method of claim 5 wherein said two coils are wrapped around magnetic metal.

7. The method of claim 6 wherein said two coils are wrapped around one rod consisting of magnetic metal.

8. The method of claim 6 wherein the two coils is each wrapped around one end of a rod, wherein the ends consists of magnetic metal and a middle part of the rod consists of plastic.

9. The method of claim 5 wherein the anchor is a rod moving inside of two parallel coils and consists of a permanent magnet.

10. The method of claim 9 wherein rod is a neodymium magnet.

11. The method of claim 9 wherein a tube consisting of magnetic metal is deployed around the coils.

12. The method of claim 11 wherein said tube has openings on its surface.

13. The method of claim 1 wherein said linear motor comprises one coil.

14. The method of claim 13 wherein said coil is wrapped around magnetic material.

15. The method of claim 13 wherein the anchor is a rod moving inside of the coil and consists of a permanent magnet.

16. The method of claim 15 wherein a tube consisting of magnetic metal is deployed around the coil.

17. The method of claim 16 wherein said tube has openings on its surface.

18. The method of claim 1 wherein said anchor comprises two permanent magnets.

19. The method of claim 18 wherein said two permanent magnets are deployed on a same side of the coils.

20. The method of claim 18 wherein said two permanent magnets are deployed on opposite sides of the coils.

21. The method of claim 1 wherein said pulse generating means are two buffers.

22. The method of claim 1 wherein said anchor is driven by pulse-width-modulation pulses.

23. The method of claim 1 wherein said sensing of inductance is performed by sensing a difference of inductance of two coils used.

24. The method of claim 1 wherein said sensing of inductance is performed using sample-and-hold circuitry.

25. The method of claim 1 wherein said sensing of inductance is performed by sensing an absolute value of inductance of a coil used.

26. The method of claim 1 wherein two coils of the motor are driven in parallel if a high torque is required.

27. The method of claim 26 wherein a modulation of several KHz is given additionally to the two coils if a high torque is required.

28. The method of claim 1 wherein during a part of duration of a motor control period the motor moves the anchor and during the rest of the motor control period the inductance of one or more coils is sensed.

29. The method of claim 28 wherein about 80% of the motor control period is used for driving the motor.

30. The method of claim 1 wherein, in case the anchor is close to the target position, the driving force of the motor is reduced and more time is spent for said sensing the inductance.

31. A linear motor having an integrated position sensing of an anchor of the motor, comprises:
at least one coil to drive the anchor of the motor;
a means to generate electrical pulses;
said anchor comprising at least one permanent magnet;
a means to sense the inductance of the at least one coil wherein the inductance of at least one coil is dependent upon the position of said anchor; and
a control unit to control driving of the anchor and the sensing of the inductance.

32. The linear motor of claim 31 wherein said linear motor is used in a camera module.

33. The linear motor of claim 32 wherein said linear motor is used to move a lens barrel.

34. The linear motor of claim 32 wherein said linear motor is used to move a shutter.

35. The linear motor of claim 31 wherein said linear motor comprises two coils.

36. The linear motor of claim 35 wherein said two coils are wrapped around magnetic metal.

37. The linear motor of claim 36 wherein said two coils are wrapped around one rod consisting of magnetic metal.

38. The linear motor of claim 36 wherein the two coils is each wrapped around one end of a rod, wherein the ends consists of magnetic metal and a middle part of the rod consists of plastic.

39. The linear motor of claim 35 wherein the anchor is a rod moving inside of two parallel coils and consists of a permanent magnet.

40. The linear motor of claim 39 wherein rod is a neodymium magnet.

41. The linear motor of claim 39 wherein a tube consisting of magnetic metal is deployed around the coils.

42. The linear motor of claim 41 wherein said tube has openings on its surface.

43. The linear motor of claim 31 wherein said linear motor comprises one coil.

44. The linear motor of claim 43 wherein said coil is wrapped around magnetic material.

45. The linear motor of claim 43 wherein the anchor is a rod moving inside of the coil and consists of a permanent magnet.

46. The linear motor of claim 45 wherein a tube consisting of magnetic metal is deployed around the coil.

47. The linear motor of claim 46 wherein said tube has openings on its surface.

48. The linear motor of claim 31 wherein said anchor comprises two permanent magnets.

49. The linear motor of claim 48 wherein said two permanent magnets are deployed on a same side of the coils.

50. The linear motor of claim 48 wherein said two permanent magnets are deployed on opposite sides of the coils.

51. The linear motor of claim 31 wherein said pulse generating means are two buffers.

52. The linear motor of claim 31 wherein said anchor is driven by pulse-width-modulation pulses.

53. The linear motor of claim 31 wherein said sensing of inductance is performed by sensing a difference of inductance of two coils used.

54. The linear motor of claim 31 wherein said sensing of inductance is performed using sample-and-hold circuitry.

55. The linear motor of claim 31 wherein said sensing of inductance is performed by sensing an absolute value of inductance of a coil used.

56. The linear motor of claim 31 wherein two coils of the motor are driven in parallel if a high torque is required.

57. The linear motor of claim 56 wherein a modulation of several KHz is given additionally to the two coils if a high torque is required.

58. The linear motor of claim 31 wherein during a part of duration of a motor control period the motor moves the anchor and during the rest of the motor control period the inductance of one or more coils is sensed.

59. The linear motor of claim 38 wherein about 80% of the motor control period is used for driving the motor.

60. The linear motor of claim 31 wherein, in case the anchor is close to the target position, the driving force of the motor is reduced and more time is spent for said sensing the inductance.

61. A camera using linear motors having integrated position sensing for positioning of components comprising:
an image sensor;
a shutter with an aperture function driven by a linear motor;
said linear motor driving the shutter, wherein the motor has an integrated position sensing system;
a movable lens barrel;
at least two linear motors moving to move said lens barrel;
an integrated circuit controlling the motor driving the shutter and the actuators moving the lens barrel; and
rolling elements bearings guiding said lens barrel and said shutter, wherein the rolling elements of the bearings are moving between moving and fixed components of the camera module.

62. The camera of claim 61 wherein said rolling elements bearings are ball bearings.

63. The camera of claim 61 wherein said rolling elements bearings are roller bearings.

64. The camera of claim 61 wherein each of said two linear motors moving the lens barrel comprises two coils and two permanent magnets.

65. The camera of claim 61 wherein a positioning of the shutter is used as an aperture.
